(19) United States
(12) Patent Application Publication
(10) Pub. No.: US 2005/0100170 A1
(43) Pub. Date: May 12, 2005

(54) Method of recording and playing compact disk quality sound signals for a doorbell system, and a receiver embodying such method

(76) Inventor: Kun Li Chen, Kee Long City (TW)

Correspondence Address: MARTINE PENILLA & GENCARELLA, LLP, 710 LAKEWAY DRIVE, SUITE 200, SUNNYVALE, CA, 94085, US

(21) Appl. No.: 10/745,971

(22) Filed: Dec. 24, 2003

(30) Foreign Application Priority Data
Nov. 10, 2003 (MY) PI 20034295

(51) Int. Cl. H04R 29/00

(52) U.S. Cl. 381/59

(57) ABSTRACT

According to the present invention, a method of recording and playing compact disk (CD) quality sound signals for a doorbell system is taught. Wave-formatted sound signals are first sourced either from websites or musical instrument generated files or recordings. These sound files are edited into 16 KHz/16 bits or higher resolutions. Optionally, 16 KHz/16 bits or higher sound signals can be tuned with echo effect. Optionally, sound signals are separated into specific segments. Next, the 16 KHz/16 bits or higher tunes are converted into 16 KHz/12 bits or higher binary data. The 16 KHz/12 bits or higher sound signals are embodied into a voice-based microprocessor (1.11). Finally, the 12 bits binary data are played as analog sound signals with the assistance of a built-in digital-to-analog converter (DAC) (1.10) in the microprocessor (1.11). A receiver of a doorbell system embodying the above stated method is also disclosed. The doorbell system can be a wireless or a wired version.

### TECHNICAL FIELD

This invention relates generally to compact disk (CD) quality sound signals. In particular, it relates to a method of recording and playing the CD quality sound signals for a doorbell system, using a voice-based microprocessor, and a receiver embodying such method.

### BACKGROUND OF THE INVENTION

A compact disk (CD) player is an example of a system in which both digital and analog circuits are used. Music in graphic form is stored in the CD. A laser diode optical system picks up digital data from a rotating disk and transfers it to a digital-to-analog converter (DAC). The DAC changes the digital data into an analog signal that is an electrical reproduction of the original music. This signal is amplified and sent to a speaker. When the music is originally recorded in the CD, this process is essentially the reverse of the one described above, using an analog-to-digital converter (ADC).

Prior art electronic doorbells producing artificial sound signals are generated by melody synthesizer integrated circuits (ICs). These artificial sounds are generally of poor quality and do not correspond to sound signals from musical instruments, such as bells, flutes, saxophones and the like.

Prior art doorbell systems generally employ 8 KHz play-rate and 8 bits resolution. U.S. Pat. No. 6,545,595 cited parameters of CD quality as 8 bits 8 KHz. The sound quality with these parameters is toy-like and does not qualify as CD quality. Modern technologies of sound recording, generating, editing and tune/melody composing have improved substantially. Commonly recognized CD quality refers the amplitude resolution of 8, 12, 16 bits or higher; and the play-rate of 11.025 KHz, 16 KHz, 22.05 KHz, or 44 KHz. The parameters can be combined to engineer sound spectrum to suit intended application where the chosen sound quality is appropriate for a doorbell system. Typically, a doorbell system with hardware architecture of a voice-based microprocessor, a 12 bit DAC at 16 KHz play-rate, and a 64K/128K/256K/512K memory size can be designed in accordance with the present invention.

### SUMMARY OF THE INVENTION

In order to achieve CD quality sound signals with a play-rate of 16 KHz and 12 bits or higher resolution, this invention teaches a method of recording and playing such quality sound signal for a doorbell system. The method comprises the steps of: sourcing, recording, and generating wave-formatted sound signals or tunes, processing and editing sound signals or tunes, converting tunes into 16 KHz/12 bits binary data, embodying the binary data into a voice-based microprocessor, playing the stored binary data with the assistance of a DAC, and amplifying the CD quality sound through an audio amplifier and a sound playing means, such as a loudspeaker.

A microprocessor is employed. The microprocessor is preferably equipped with built-in voice ROM and DAC, i.e., a voice-based microprocessor. Alternatively, a microprocessor with built-in DAC may be used associating an external ROM for data storage; or a microprocessor with built-in relatively large memory size to store sound data may be used with an external DAC to convert digital signals into analogue sound signals. Thus, a receiver of a doorbell system with a voice-based microprocessor, embodying the above method, is also taught, playing various musical instrument tunes.

### BRIEF DESCRIPTION OF THE DRAWINGS

The present invention overcomes the disadvantages of prior art doorbell system and its associated poor sound quality. The invention will become apparent from the following description when read in conjunction with the accompanying drawings in which:

FIG. 1 is a flow diagram depicting a method of sourcing, recording, generating, processing, editing and playing CD quality sound signals according to the present invention.

FIG. 2a is a block diagram depicting how the CD quality sound embodied in a receiver of a wireless version of a doorbell system is structured and played.

FIG. 2b is a circuit diagram depicting the operation of a radio frequency (RF) receiver in FIG. 2a.

FIG. 3a is a block diagram depicting how the CD quality sound embodied in a receiver of a wired version of a doorbell system is structured and played.

FIG. 3b is a circuit diagram depicting the wired version in FIG. 3a.

### DETAILED DESCRIPTION

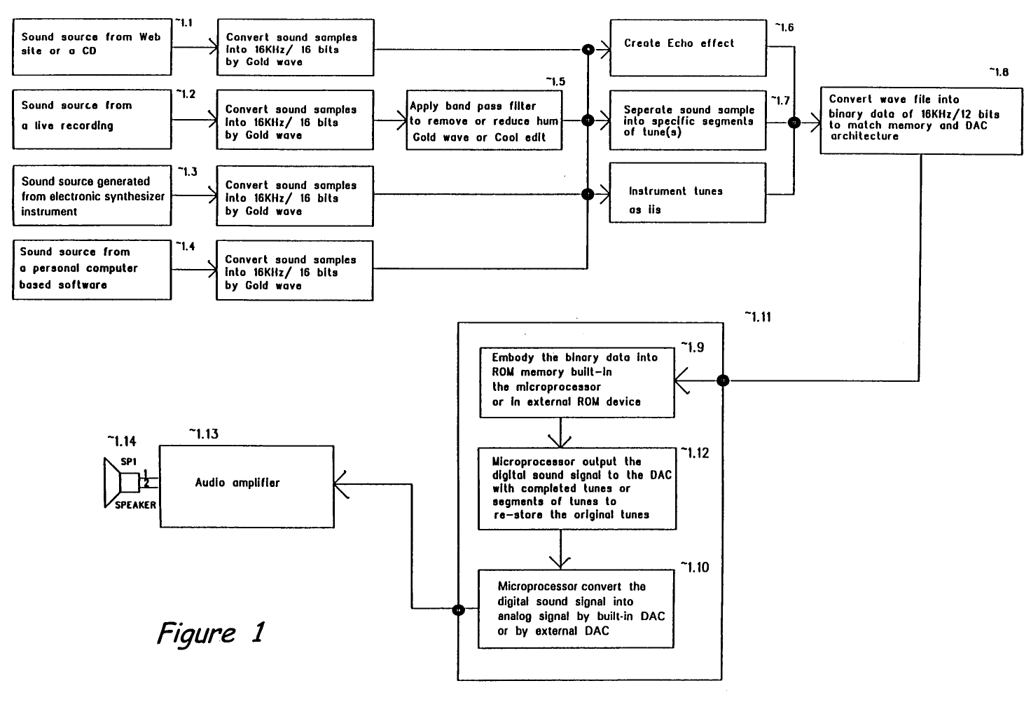

Referring to FIG. 1, a receiver unit having a sound memory for storing and playing a compact disk (CD) quality sound is referred. A doorbell system typically includes a receiver unit for receiving an indication of a doorbell button or a transmitter being pressed, a code detector for commanding the sound memory to output stored CD quality sound signals and sound producing means for outputting the CD quality sound. A voice-based microprocessor, cooperating with a built-in or external sound storage memory and a built-in or external digital-to-analog converter (DAC) is a key element in the present invention.

Digital sound signal (of a wave format) can be sourced from a web site or a CD (1.1). Various musical instrument sound samples and libraries may be offered from web sites, various musical instrument sounds or tunes may be available through existing musical records and CDs. This sourced sound can be a single note or a complete tune for further processing.

Digital sound signal can be live recording (1.2). Musical instruments, such as saxophones, can be played in well-equipped audio studio, and the tunes are recorded and digitized at high resolution levels such as 44 KHz/16 bits. This recording can be a single note or a complete tune for further processing.

The digital sound signals can also be generated from electronic synthesizer instrument (1.3). Electronic musical keyboards, such as Yamaha or Casio keyboards, are used to generate tube bell and recorded as either MIDI files or Wave files. This sound generation can be a single note or a complete tune for further processing.

The digital sound signals can also be generated and composed into tunes from a personal computer based software (1.4). A musical instrument sound characteristics and parameters can be identified through sample recorded sound or tune, extracted and based on to generate and compose into tunes as required. For example, a sound processing sampling machine, with a software such as Giga Sampler on Windows system, is used to find the parameters of the sound signals, which later are composed into a completed tune using a sound composition software, such as the Cakewalk, with the Giga Sampler as the output device. After the completion of the composition, the Cakewalk is again used to fine-tune and edit the completed tune if desirable. After validation, this completed melody is ready for further converting and processing by another software such as Gold Wave.

A good quality sound source should embody a higher play-rate and resolution, such as 44 KHz/16 bits. Although a 44 KHz/16 bits sound is of good quality, it takes up a lot of memory space for storage. Most microprocessors are not structured to handle such high quality sound due to economical reason.

A personal computer with multi-media sound card and sound editing software, such as Gold Wave or Cool Edit, is employed to convert such high resolution sounds to 16 KHz/16 bits sound quality for further processing. After the above conversion, the lower 16 KHz/16 bits sound may have some hum and noise. A band pass filter from sound processing software such as Gold Wave is employed. Generally, this filtering step (1.5) to remove the AC hum is only applied when the sound source is recorded live. During the design of the CD quality sound according to the invention, part of the melody, such as the Big Ben series, usually operates at such parameters as 44 KHz/16 bits. In that case, the filtering step is optional. Equalizer from sound processing software such as Gold Wave is sometimes employed to boost the bass band or the treble band.

Different tune processing is optionally applied after the above noise reduction of the digitized sound signals. In one situation, an echo effect (1.6) is optionally introduced to the sound signals. In another situation, the memory space used by tune(s) with a higher play-rate and resolution, such as Big Ben, big church bell, mini-bell, tube bell tune and the like, can be reduced by separating it into specific segments of tunes (1.7). In the case of the Big Ben 8 note, Big Ben 4 note, Big Ben 2 note and Big Ben single note, we can separate the tune(s) into separate segments before masking the microprocessor and then re-assemble them while playing the tune(s) according to the real design of a doorbell system. In doing so, the memory space is reduced and the tune(s) can be recovered from the real design without any impact on its original sound quality. To achieve this purpose, we need to create the Big Ben 1^{st}, 2^{nd}, 3^{rd}, . . . 8^{th} note from the existing tune(s) collection and then conduct a further sound processing.

With the assistance of a special software (1.8), these tunes in wave formatted sound signals are converted into binary formatted sound signals of 16 KHz/12 bits or higher resolution, which is compatible to the microprocessor used. Although 4 bits resolution is lost after the conversion, the sound quality is still superior to that of 8 bits.

The binary formatted sound signals of 16 KHz/12 bits or higher are embodied into the memory (1.9) of a voice-based microprocessor (1.11). The converted binary data will be put together by a main program for masking into the microprocessor. Once this is done, there is no need to further download or record the tune or melody.

The voice-based microprocessor (1.11) is equipped with a built-in ROM (1.9) and a 12 bits or higher DAC (1.10). For playing recorded instrument tunes or the bell tune with echo effect, the microprocessor simply outputs the data to play the original sound. For the bell tune without echo effect, the microprocessor (1.11) outputs the data with the assistance of software utilities (1.12).

Any sound source with less than 16 KHz/12 bits would generate poor quality sound, since its sound-to-noise (S/N) ratio will be poor, distortion will make the sound lose the original sound effect. With higher resolution, the sound tune, such as Big Ben, church bell, mini-bell, some instrument sounds like saxophone, flute and the like, can be used in the doorbell system.

The well-known rank order filter or median filter commonly used for image filtering is not employed, since the 16 KHz/12 bits sound signals are fairly good. For poor quality sound resolution architecture as seen with prior art at 8 KHz/8 bits, this advanced level filtering mechanism is applied to remove obvious spikes and noises exhibit in sounds.

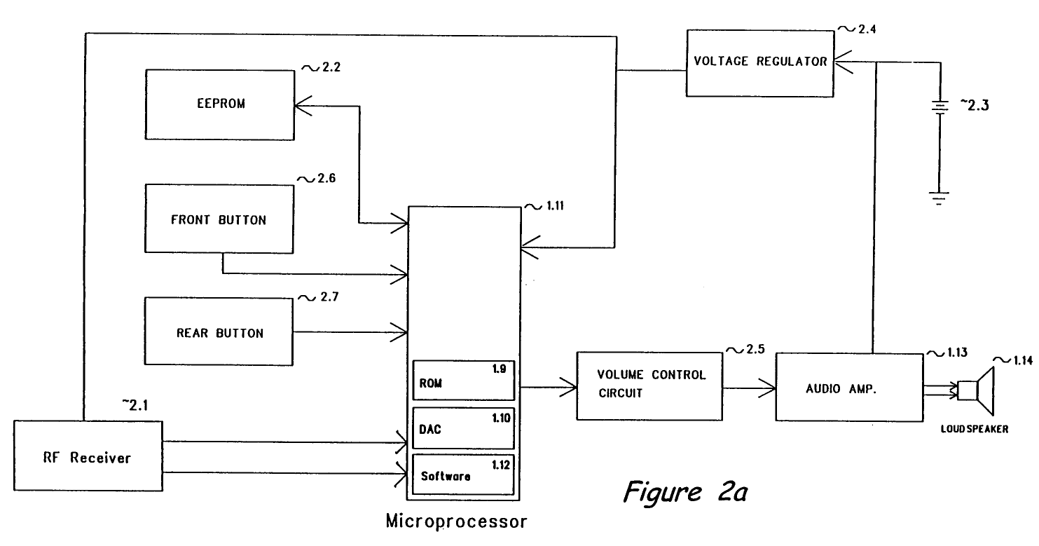

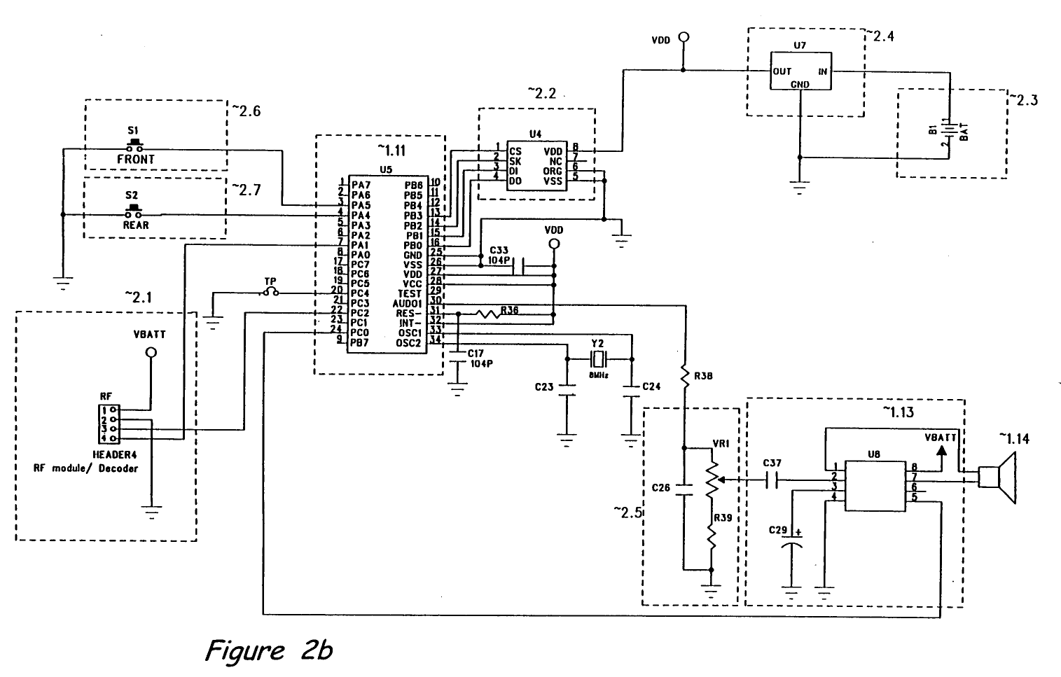

The above sound recording and playing method according to the above invention is embodied in a receiver of a doorbell system, as shown in FIGS. 2a and 2b. According to a wireless version of the invention, the CD quality sound receiver of a doorbell system comprises essentially a power supply (2.3, 2.4), an electrically erasable programmable read-only memory (EEPROM) (2.2), a radio frequency (RF) receiver (2.1), a microprocessor (1.11), a volume control circuit (2.5), an audio amplifier (1.13) and a loudspeaker device (1.14).

Referring to FIG. 2b, a battery (2.3) is connected to the audio amplifier (1.13) as power source and the same voltage is connected to a voltage regulator (2.4) to regulate the voltage at 3.3V as the supply voltage for the microprocessor (1.11), such as HT 86192 made by Holtek, the EEPROM (2.2) and the RF receiver (2.1). It is important to note that the microprocessor (1.11) can be associated with a built-in DAC (1.10) and an external memory (1.9). Alternatively, the microprocessor (1.11) can also be associated with a built-in memory (1.9) and an external DAC (1.10). The microprocessor (1.11), when on standby, will operate in sleep mode. An associated oscillator is disabled for conservation of the battery energy and the microprocessor (1.11) will cease any operation until there is a valid falling pulse from input pins to wake it up. Once one of the transmitters (not shown) of the doorbell system transmits its ID code through RF media, the RF receiver (2.1) will capture this signal, filters the ID code and then sends out a falling edge signal to wake up the microprocessor (1.11), which then operates to decode the ID code. The microprocessor (1.11) will further scan the decoded ID code to see whether it matches with an ID code that has been previously stored in the EEPROM (2.2). If the decoded ID code does not match with the stored ID code, the microprocessor (1.11) will revert back to the sleep mode. If the decoded ID code matches the stored ID code, then the microprocessor (1.11) will acknowledge the ID code and then starts to generate the CD quality sound by the following steps:
1. Call the binary format data that has been embodied in the voice-based ROM (1.9) of the microprocessor (1.11).
2. Convert the binary format data into a DC voltage with a level referring to the value of the binary data through the 12 bits DAC (1.10) of the microprocessor (1.11).
3. The binary data is actually converted from the original analog sound signals. The 12 bits DAC recovers the amplitude of the 12 bits at the right speed 16 KHz that are the same as the original resample rate so as to recover the time domain of the original analog sound. With this, the microprocessor (1.11) is then capable of regenerating the original analog sound with almost no distortion from its output pin.
4. The microprocessor (1.11) will then output the analog signal to the volume control circuit (2.5) through resistor R38 and capacitor C26 used for filtering the high frequency harmonics that are generated from the microprocessor (1.11) itself, as well as other random noises or spikes. A variable resistor VR1 cooperates with resistor R39 acting as the voltage divider to limit the amplitude of the analog signals as well as to control the volume of the sound.
5. Capacitor C37 is a DC blocking capacitor to remove the DC bias from the audio signal and only allow the true audio signals to get into the audio amplifier (1.13).
6. The audio amplifier (1.13), such as HT82V733, is introduced to enlarge the amplitude of the audio signals to a level that is capable of driving the loudspeaker (1.14). The output stage of the audio amplifier (1.13) is in the form of a bridge that filters off the AC hum and drives the loudspeaker (1.14) to recover the original analog sound.
7. When the reproduction of the sound is done, then the microprocessor (1.11) will revert back to the sleep condition again and await further valid instruction.

The sounds that have been previously stored in the built-in voice ROM (1.9) can be further selected through the button(s), either the front button (2.6) or the rear button (2.7). According to the original design of the invention, the first programmed transmitter represented by the front button (2.6) activates a first default sound and the second programmed transmitter represented by the rear button (2.7) activates a second default sound. Depressing a button serves to scroll the sounds that are available in the voice ROM (1.9) and changes the represented sound of the transmitter.

The original sound source is converted into a pulse code modulation (PCM) format that is applicable to be stored in a hardware ROM (1.9) device either as an independent part or as a built-in application. After the conversion from original sound source into the binary data or the PCM format data, the hardware device like the microprocessor (1.11), such as HT86192, is capable of recovering the original sound source in its audio output pin by means of the built-in DAC and the correct playback speed. To maintain the original sound with good quality and to reduce the ROM storage space of the PCM data that is equivalent to the original sound, therefore the resolution of the amplitude of at least 12 bits and the resample rate of at least 16 KHz will be the basic requirement to regenerate the CD quality sound. Either the re-sample rate or the resolution of the amplitude lower than these figures will cause sound distortion when recovering the original sound through the hardware device.

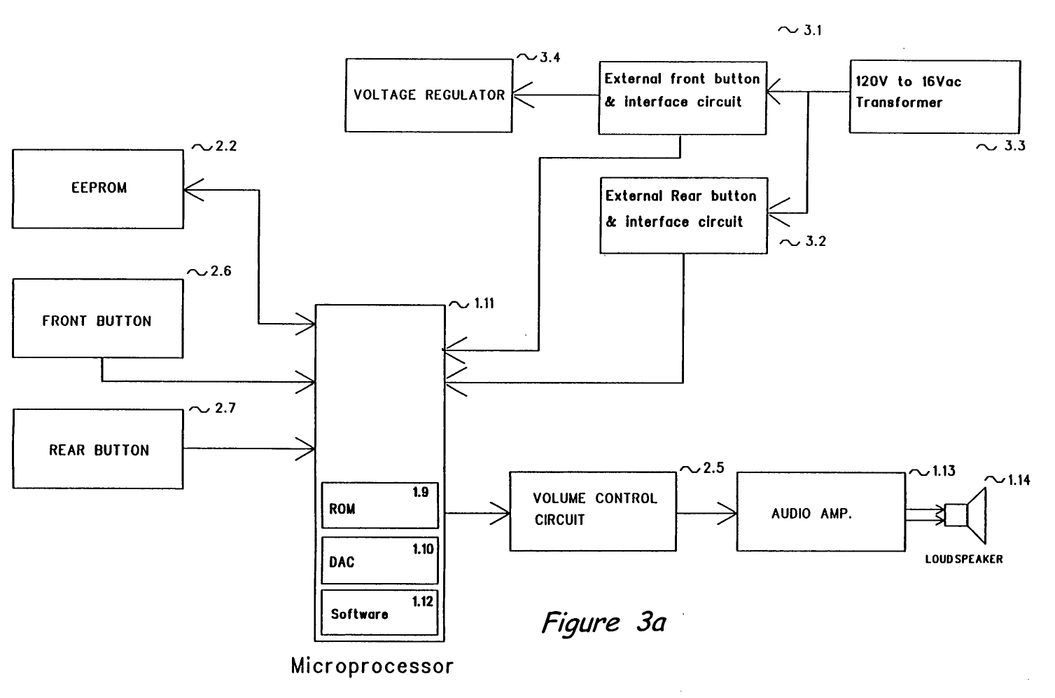

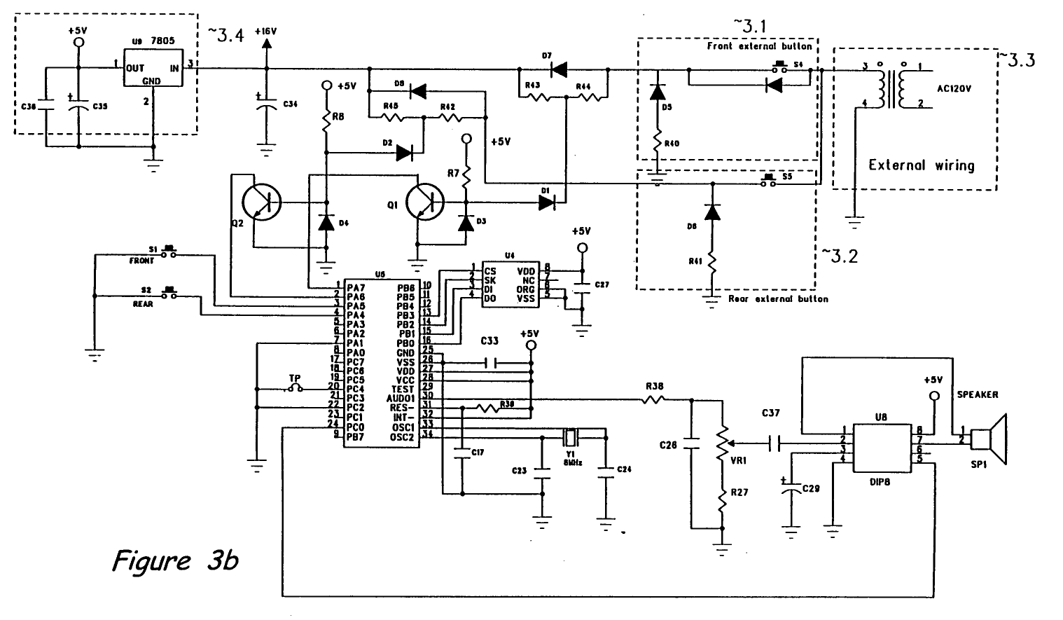

According to a wired version of the present invention as seen in FIGS. 3a and 3b, no RF receiver is employed. Two external buttons (3.1, 3.2) are added and located elsewhere in a building serviced by the doorbell system. The power supply is appropriately modified. The microprocessor (1.11) acknowledges the depression of each external button as a triggering input and responds with a respective tune output. For an example, the external button (3.1) can be the front door button and the external button (3.2) can be the rear door button. Depressing a different button will excite a different tune. This different tune can be selectively changed or selected with the assistance of the front button (2.6) or the rear button (2.7).

1. A method of recording and playing compact disk (CD) quality sound signals or tunes for a doorbell system comprises the steps of:
sourcing wave-formatted sound signals or tunes (1.1, 1.2, 1.3, 1.4),
converting sound signals or tunes into 16 KHz/12 bits or higher binary data (CD quality sounds) (1.8),
embodying the binary data into a memory (1.9) of a microprocessor (1.11),
playing the binary data stored with the assistance of a digital-to-analog converter (DAC) (1.10), and
amplifying the CD quality sounds through an audio amplifier (1.13) and a sound playing means such as a loudspeaker (1.14).

2. A CD quality sound recording and playing method as in claim 1 in which the digital sound signals are from a CD ROM or downloaded from a web site (1.1).

3. A CD quality sound recording and playing method as in claim 1 in which the digital sound signals are recorded live (1.2).

4. A CD quality sound recording and playing method as in claim 1 in which the digital sound signals are created through an electronic synthesizer instrument (1.3).

5. A CD quality sound recording and playing method as in claim 1 in which the digital sound signals are created through a computer software (1.4).

6. A CD quality sound recording and playing method as in claim 2 or 3 or 4 or 5 in which a low band pass filter is applied to the sound signals sourced from recording (1.5).

7. A CD quality sound recording and playing method as in claim 1 in which 16 KHz/12 bits or higher resolutions (CD quality sounds) are optionally tuned with echo effect (1.6).

8. A CD quality sound recording and playing method as in claim 1 in which 16 KHz/12 bits or higher tunes (CD quality sounds) are optionally separated into specific segments (1.7) while editing, and the CD quality sound is assembled and played through combination of these segments by software utilities (1.12) of the microprocessor (1.11).

9. A CD quality sound recording and playing method as in claim 1 in which the microprocessor (1.11) is associated with a built-in or external ROM (1.9) storing digital sound data in binary format.

10. A CD quality sound recording and playing method as in claim 1 in which the microprocessor (1.11) is associated with a built-in or external 12 bits or higher digital-to-analog converter (DAC) (1.10).

11. A receiver of a doorbell system playing CD quality sound, comprising:
a receiver (2.1) that responds to external buttons (3.1, 3.2);
a microprocessor (1.11);
a memory unit (1.9);
a digital-to-analogue converter (DAC) (1.10);
an audio amplifier (1.13); and
a loudspeaker (1.14), is characterized in which CD quality sounds are masked to a built-in ROM of the microprocessor (1.11) or an external ROM (1.9), and is later played after being instructed by the microprocessor (1.11) confirming a code from a transmitter or the external buttons (3.1, 3.2) of a doorbell system.

12. A receiver of a doorbell system playing CD quality sound as in claim 11 in which the CD quality sounds operate with a specification of 12 bits resolution or higher and 16 KHz sample rate or higher.

13. A receiver of a doorbell system playing CD quality sound as in claim 11 in which the microprocessor (1.11) includes a 12 bits or higher digital-to-analog converter (DAC) (1.10) and a relatively large memory size (1.9).

14. A receiver of a doorbell system playing CD quality sound as in claim 11 in which the receiver is in wireless communication with the transmitter through a radio frequency receiver (2.1).

15. A receiver of a doorbell system playing CD quality sound as in claim 11 in which the receiver is in wired communication with external buttons (3.1, 3.2) located elsewhere in a building.
